(19) United States
(12) Patent Application Publication
(10) Pub. No.: US 2016/0119282 A1
(43) Pub. Date: Apr. 28, 2016

(54) DOMAIN NAME REGISTRATION VERIFICATION

(71) Applicant: Go Daddy Operating Company, LLC, Scottsdale, AZ (US)

(72) Inventor: James M. Bladel, Le Claire, IA (US)

(21) Appl. No.: 14/522,467

(22) Filed: Oct. 23, 2014

(51) Int. Cl. H04L 29/12; G06Q 30/00; G06F 17/30

(52) U.S. Cl. CPC H04L 61/302; G06F 17/30864; G06F 17/30424; G06Q 30/018

(57) ABSTRACT

Systems and methods of the present invention provide for one or more server computers communicatively coupled to a network and configured to: identify a domain name; request, access and/or download, from an electronic repository of domain name data, a historical data associated with the domain name; parse, from the historical data, at least one transaction associated with the domain name; calculate, according to the at least one transaction, a level of confidence that a history of registration of the domain name is complete and accurate; and transmit the historical data to a client computer communicatively coupled to the network.

### FIELD OF THE INVENTION

The present inventions generally relate to the field of domain names and specifically to the field of verifying control of a domain name registration according to a registration history associated with the domain name.

### SUMMARY OF THE INVENTION

The present inventions provide methods and systems comprising one or more server computers communicatively coupled to a network and configured to: identify a domain name; request, access and/or download, from an electronic repository of domain name data, a historical data associated with the domain name; parse, from the historical data, at least one transaction associated with the domain name; calculate, according to the at least one transaction, a level of confidence that a history of registration of the domain name is complete and accurate; and transmit the historical data to a client computer communicatively coupled to the network.

The above features and advantages of the present invention will be better understood from the following detailed description taken in conjunction with the accompanying drawings.

### BRIEF DESCRIPTION OF THE DRAWINGS

FIG. 1 is a flow diagram illustrating a possible embodiment of a method for performing a domain name title search.

FIG. 2 illustrates a possible system for performing a domain name title search.

FIG. 3 illustrates a more detailed possible system for performing a domain name title search.

FIG. 4 is a flow diagram illustrating a possible embodiment of a method for performing a domain name title search.

FIG. 5 is a flow diagram illustrating a possible embodiment of a method for performing a domain name title search.

FIG. 6 is a flow diagram illustrating a possible embodiment of a method for performing a domain name title search.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as websites. The combination of all the websites and their corresponding web pages on the Internet is generally known as the World Wide Web (WWW) or simply the Web.

Prevalent on the Web are multimedia websites, some of which may offer and sell goods and services to individuals and organizations. Websites may consist of a single webpage, but typically consist of multiple interconnected and related web pages. Websites, unless extremely large and complex or have unusual traffic demands, typically reside on a single server and are prepared and maintained by a single individual or entity. Website browsers are able to locate specific websites because each website, resource, and computer on the Internet has a unique Internet Protocol (IP) address.

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses.

Because domain names facilitate convenient access to various Internet resources, the perceived value of some domain names has increased over time. As domain names become available in the domain name aftermarket, some domain name registrants have been willing to pay thousands or even millions of dollars for what the market suggests are high-value domain names.

The high value of such domain names, as well as other factors, may create the illusion of ownership of the domain name as a property. However, despite domain name registrants and/or assignees often being referred to as the domain name “owners,” registering and/or transferring a domain name conveys no ownership rights or property title in the domain name.

Nevertheless, the illusion of ownership and property title provides a convenient analogy to better understand and explain the disclosed invention. Thus, for purposes of this disclosure, title may be defined as the control granted to a registrant over a domain name when the domain name is registered, transferred and/or assigned; title search may be defined as aggregating and/or analyzing a domain name history, according to the disclosed domain name data sources, to verify control over a domain name by a registrant, thereby creating confidence in the registrant and their control of the domain name; chain of title may be defined as evidence of control, or a lack thereof, over the domain name by a registrant or series of registrants; and a cloud on the title may be defined as any event or transaction in the domain name history that calls control over the domain name, by the registrant(s), into question.

WHOIS records represent a non-limiting example of one or more domain name resources used to provide information associated with a registration for a domain name by a registrant. WHOIS records are generated and available via a transaction-oriented query/response protocol used to provide domain name registration information services to Internet users.

Example domain name registration information may be seen in the following simplified WHOIS record:

Whois v1.11 - Domain information lookup utility
Domain Name: EXAMPLE.COM
Registrant: JOHN DOE
Registrar: EXAMPLEREGISTRAR.COM, INC.
Whois Server: whois.exampleregister.com
Referral URL: http://www.exampleregister.com
Name Server: DNS01.EXAMPLESERVER.COM
Name Server: DNS02.EXAMPLESERVER.COM
Web Site Status: ACTIVE
Record Created: 01-Jan-2013
Updated Date: 01-Jan-2014
Data as of: 01-Jan-2014
Record Expires On: 01-Jan-2016
Database Last Updated On: 01-Jan-2014

In addition to the WHOIS data above, the WHOIS record may also include any other data relevant to the domain name registration, such as registrant, administrative, technical, and billing information for the domain name.

The transparency into domain name ownership provided by WHOIS records, as well as the high value associated with some domain names, have caused some unscrupulous individuals to hijack the registration and control of domain names. Domain name hijacking or domain name theft can involve changing the registration of a domain name without the permission of its original registrant. As non-limiting examples, a domain name hijacker may acquire personal information about the actual domain owner, possibly from WHOIS information, and impersonate them in order to persuade the domain registrar to modify the registration information and/or transfer the domain name to another registrar (the hijacker), who would then gain full control of the domain name.

To counteract unscrupulous domain name transactions such as domain name hijacking, the World Intellectual Property Organization (WIPO), ICANN, domain name registries and registrars, the United States judicial system and other domain name registration authorities have established the Uniform Domain-Name Dispute-Resolution Policy (UDRP) as a mandatory administrative procedure concerning abusive registrations, which allows for a neutral venue in the context of domain name disputes.

Unfortunately, such administrative procedures may have the unintended consequence of undermining confidence in purchases made through a domain name aftermarket. As a specific example, a new registrant for a domain name in such aftermarket may purchase the rights to transfer and control registration of a domain name, only to have a domain name registration authority or court, many months after the domain name registration, reverse the transaction, and by extension, control of the domain name, if another claimant prevails in a domain name dispute.

Applicant has determined that presently existing methods and systems provide no means to avoid such ambiguity by determining if all records for a domain name history are complete and verified, and that the domain registrant's control over the domain name is recognized across all domain name registrars.

Applicant has therefore determined that optimal systems and methods may improve on presently-existing systems and methods by providing a title search system used to verify the domain name registrant's title in the domain name. Such systems and their accompanying method steps may allow the seller to research a history of control over the domain name to offer verified domain names in a domain name aftermarket. Buyers may likewise register and/or transfer domain names in the domain name aftermarket with confidence that the domain name will be free of domain name control issues or domain-related disputes.

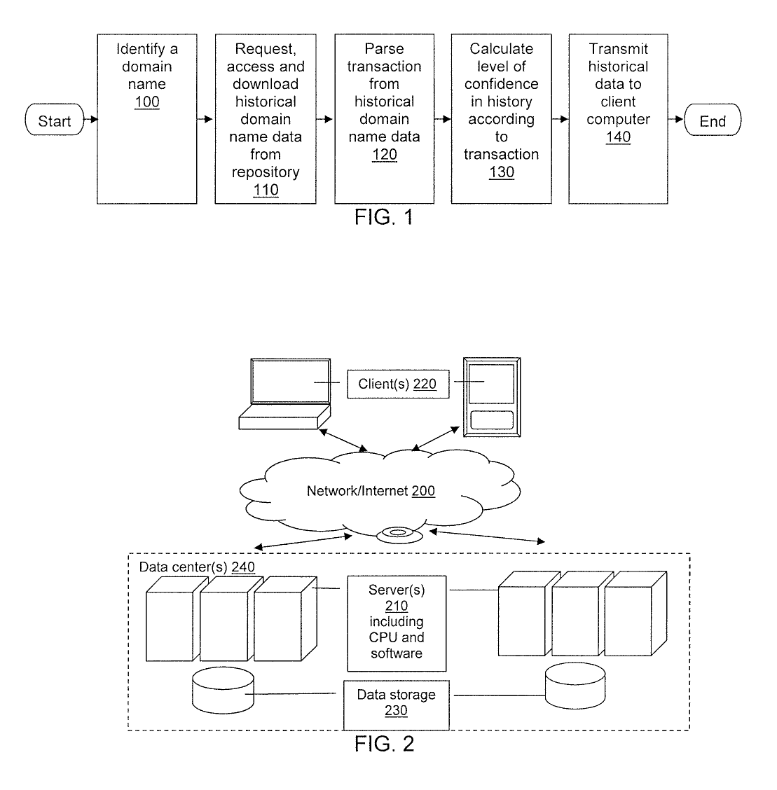

Several different methods may be used to provide and manage the present systems. In the example embodiment shown in FIG. 1, one or more server computers may be communicatively coupled to a network and operated by a hosting provider hosting a plurality of business websites. These server(s) may be configured to: identify a domain name (Step 100); request, access and/or download, from an electronic repository of domain name data, a historical data associated with the domain name (Step 110); parse, from the historical data, at least one transaction associated with the domain name (Step 120); calculate, according to the at least one transaction, a level of confidence that a history of control of the domain name is complete and accurate (Step 120); and transmit the historical data to a client computer communicatively coupled to the network 100.

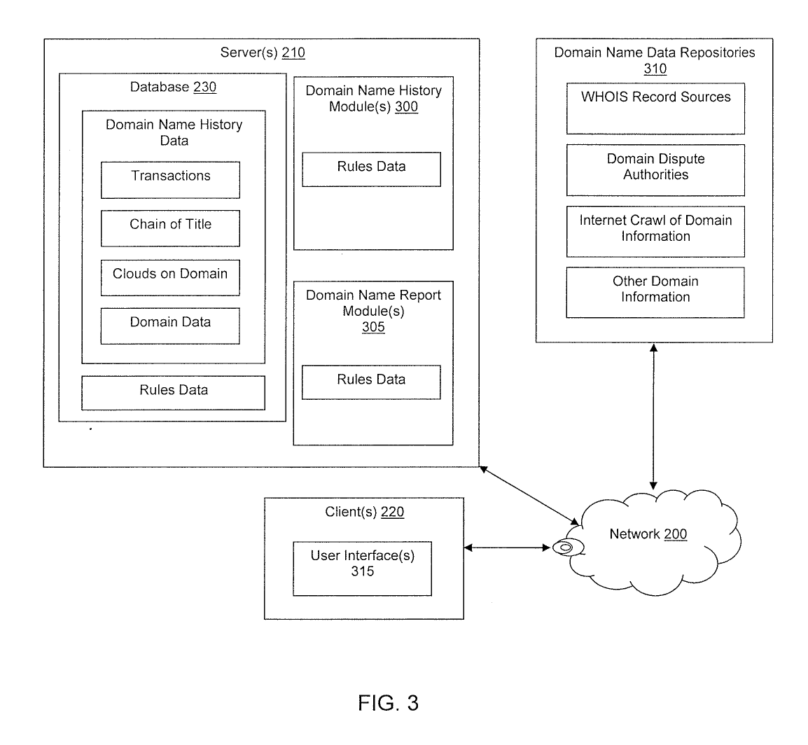

Several different environments may be used to accomplish the method steps of embodiments disclosed herein. FIG. 2 demonstrates a streamlined example and FIG. 3 demonstrates a more detailed example of an environment including a system and/or structure that may be used to accomplish the methods and embodiments disclosed and described herein. Such methods may be performed by any central processing unit (CPU) in any computing system, such as a microprocessor running on at least one server 210 and/or client 220, and executing instructions stored (perhaps as scripts and/or software, possibly as software modules/components) in computer-readable media accessible to the CPU, such as a hard disk drive on a server 210 and/or client 220.

The example embodiments shown and described herein exist within the framework of a network 200 and should not limit possible network configuration or connectivity. Such a network 200 may comprise, as non-limiting examples, any combination of the Internet, the public switched telephone network, the global Telex network, computer networks (e.g., an intranet, an extranet, a local-area network, or a wide-area network), a wired network, a wireless network, a telephone network, a corporate network backbone or any other combination of known or later developed networks.

At least one server 210 and at least one client 220 may be communicatively coupled to the network 200 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

The example embodiments herein place no limitations on whom or what may comprise users. Thus, as non-limiting examples, users may comprise any individual, entity, business, corporation, partnership, organization, governmental entity, and/or educational institution that may have occasion to organize/import contacts and/or send marketing campaigns.

Server(s) 210 may comprise any computer or program that provides services to other computers, programs, or users either in the same computer or over a computer network 200. As non-limiting examples, the server 210 may comprise application, communication, mail, database, proxy, fax, file, media, web, peer-to-peer, standalone, software, or hardware servers (i.e., server computers) and may use any server format known in the art or developed in the future (possibly a shared hosting server, a virtual dedicated hosting server, a dedicated hosting server, a cloud hosting solution, a grid hosting solution, or any combination thereof) and may be used, for example to provide access to the data needed for the software combination requested by a client 220.

The server 210 may exist within a server cluster, as illustrated. These clusters may include a group of tightly coupled computers that work together so that in many respects they can be viewed as though they are a single computer. The components may be connected to each other through fast local area networks which may improve performance and/or availability over that provided by a single computer.

The client 220 may be any computer or program that provides services to other computers, programs, or users either in the same computer or over a computer network 200. As non-limiting examples, the client 220 may be an application, communication, mail, database, proxy, fax, file, media, web, peer-to-peer, or standalone computer, cell phone, personal digital assistant (PDA), etc. which may contain an operating system, a full file system, a plurality of other necessary utilities or applications or any combination thereof on the client 220. Non limiting example programming environments for client applications may include JavaScript/AJAX (client side automation), ASP, JSP, Ruby on Rails, Python's Django, PHP, HTML pages or rich media like Flash, Flex or Silverlight.

The client(s) 220 that may be used to connect to the network 200 to accomplish the illustrated embodiments may include, but are not limited to, a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture. Client software may be used for authenticated remote access to a hosting computer or server. These may be, but are not limited to being accessed by a remote desktop program and/or a web browser, as are known in the art.

The user interface displayed on the client(s) 220 or the server(s) 210 may be any graphical, textual, scanned and/or auditory information a computer program presents to the user, and the control sequences such as keystrokes, movements of the computer mouse, selections with a touch screen, scanned information etc. used to control the program. Examples of such interfaces include any known or later developed combination of Graphical User Interfaces (GUI) or Web-based user interfaces as seen in the accompanying drawings, Touch interfaces, Conversational Interface Agents, Live User Interfaces (LUI), Command line interfaces, Non-command user interfaces, Object-oriented User Interfaces (OOUI) or Voice user interfaces. The commands received within the software combination, or any other information, may be accepted using any field, widget and/or control used in such interfaces, including but not limited to a text-box, text field, button, hyper-link, list, drop-down list, check-box, radio button, data grid, icon, graphical image, embedded link, etc.

The server 210 may be communicatively coupled to data storage 230 including any information requested or required by the system and/or described herein. The data storage 230 may be any computer components, devices, and/or recording media that may retain digital data used for computing for some interval of time. The storage may be capable of retaining stored content for any data required, on a single machine or in a cluster of computers over the network 200, in separate memory areas of the same machine such as different hard drives, or in separate partitions within the same hard drive, such as a database partition.

Non-limiting examples of the data storage 230 may include, but are not limited to, a Network Area Storage, (“NAS”), which may be a self-contained file level computer data storage connected to and supplying a computer network with file-based data storage services. The storage subsystem may also be a Storage Area Network (“SAN”—an architecture to attach remote computer storage devices to servers in such a way that the devices appear as locally attached), an NAS-SAN hybrid, any other means of central/shared storage now known or later developed or any combination thereof.

Structurally, the data storage 230 may comprise any collection of data. As non-limiting examples, the data storage 230 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage such as a magnetic media, hard drive, other disk drive, volatile memory (e.g., RAM), non-volatile memory (e.g., ROM or flash), and/or any combination thereof.

The server(s) 210 or software modules within the server(s) 210 may use query languages such as MSSQL or MySQL to retrieve the content from the data storage 230. Server-side scripting languages such as ASP, PHP, CGI/Perl, proprietary scripting software/modules/components etc. may be used to process the retrieved data. The retrieved data may be analyzed in order to determine the actions to be taken by the scripting language, including executing any method steps disclosed herein.

The software modules/components of the software combination used in the context of the current invention may be stored in the memory of—and run on—at least one server 210. As non-limiting examples of such software, the paragraphs below describe in detail the software modules/components that make up the software combination. These software modules/components may comprise software and/or scripts containing instructions that, when executed by a microprocessor on a server 210 or client 220, cause the microprocessor to accomplish the purpose of the module/component as described in detail herein. The software combination may also share information, including data from data sources and/or variables used in various algorithms executed on the servers 210 and/or clients 220 within the system, between each module/component of the software combination as needed.

A data center 240 may provide hosting services for the software combination, or any related hosted website including, but not limited to hosting one or more computers or servers in a data center 240 as well as providing the general infrastructure necessary to offer hosting services to Internet users including hardware, software, Internet web sites, hosting servers, and electronic communication means necessary to connect multiple computers and/or servers to the Internet or any other network 200.

FIG. 3 shows a more detailed example embodiment of an environment for accomplishing the systems and method steps disclosed herein. As non-limiting examples, all disclosed software modules may run on one or more server(s) 210 and may include one or more user interfaces generated by the server(s) 210 and transmitted to and displayed on the client(s) 220. The user interface(s) may be configured to receive input from the user and transmit this input to the server(s) 210 for the administration and execution of the software, using data in data storage 230 associated with the software modules.

As seen in FIG. 3, server(s) 210 may host and/or run any combination of one or more domain name history software modules 300 and/or one or more domain name report software modules 305, any combination of which may be configured to execute any or all of the method steps disclosed herein.

As a non-limiting example, the domain history software 300 may be configured to monitor one or more electronic repositories of domain name data 310 in order to determine if the domain name is verified as a low or no risk purchase for potential domain name registrants.

The electronic repositories 310 may comprise one or more electronic data sources documenting the history of registration transactions, registration disputes, news related to the domain name and/or any other information establishing a chain of control over one or more domain names.

As non-limiting examples, the electronic data sources of domain transactions may include: 1) one or more WHOIS records available from a registry, sponsoring registrar or any other entities with authority to register domain names and access related administration records; 2) data sources documenting registrations of domain names in a domain name aftermarket; 3) websites documenting a history of control of the domain name and/or other news or information about the domain name(s); 4) publicly-available databases; and/or 5) Application Programming Interfaces (API), Rich Site Summary/Really Simple Syndication (RSS) feeds, web services, etc. configured to access any of the data sources disclosed herein.

The domain history software 300 may be further configured to perform an Internet crawl to identify one or more data sources documenting the history of transactions, control disputes, news or other information establishing or affecting a chain of control of the domain name(s). The Internet crawl may be performed by software that systematically browses the World Wide Web to update the domain related content related to the domain name and/or may index the content within data storage 230. This data may later be processed by a search engine so that users can search the domain-related content more quickly. Once identified, the domain history software 300 may be configured to “scrape” the relevant data from these data sources. The data may be scraped using any computer software technique of extracting information from websites.

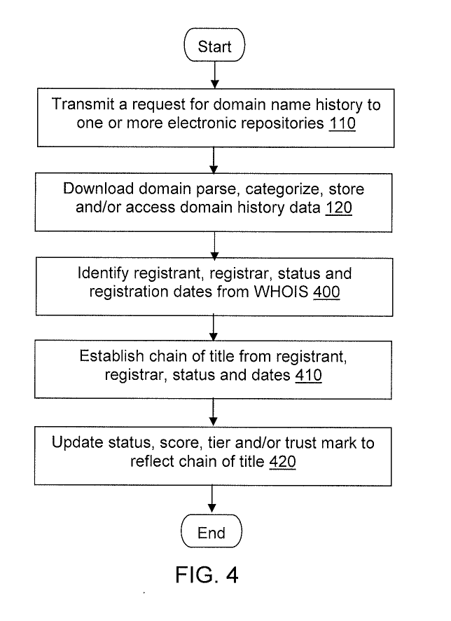

The domain history software 300 may be configured to perform the title search method illustrated in FIG. 4 by transmitting, via network 200, a request to access the one or more electronic repositories 310 (Step 100). The request may identify one or more domain names for which the historical data is requested, and may include instructions to identify and download relevant historical data about the identified domain name(s), such as transactions that define the domain name's history and/or disputes about the domain name's control.

The domain history software 300 may then download, parse, categorize store (possibly as data records in data storage 230) and/or access the domain history data relating to transactions, control disputes, news and/or other information establishing a chain of title for the domain name comprising a history of control of the domain name(s) (Step 110).

The domain history software 300 may then identify, within the downloaded and parsed domain name history data, the domain name registrant, any previous domain name registrants, a status indicating whether the domain name is active or inactive, a date the domain name was registered, a date the domain name is set to expire and/or a date of any updates to the domain name status, as non-limiting examples (Step 400).

The domain history software may use this historical data to determine any breaks in the chain of title by, for example: 1) comparing the domain registration dates with the domain with the domain expiration dates and identifying non-sequential periods where the next registration date does not immediately follow the previous expiration date; 2) ambiguities in which registrant controls the domain name (e.g., because of privacy services, such as GODADDY's DOMAINS BY PROXY, or a listed domain name registrant with a history of dishonest domain registration activity); 3) inactive status indicating periods of inactivity; and/or 4) changes in an email address as an access credential for the transfer codes and/or authorization for domain name administration.

The domain history software 300 may update data storage 230 or logic within the domain history software 300 to indicate whether the domain name has a consistent chain of title (Step 410), and may work in conjunction with the domain report software 305, as described below, to update the status, score, tier and/or trust mark associated with the domain name to reflect any identified breaks in ownership or control of the domain name title (Step 420).

As a non-limiting example, the domain history software 300 may be configured to access the previously disclosed example WHOIS record and identify: at least one range of dates during which the domain name was registered (e.g., “ Record Created: 1 Jan. 2013”—“Record Expires On: 1 Jan. 2016”); at least one registrant of the domain name, possibly comprising the current owner and any previous owners (e.g., “Registrant: JOHN DOE”) and/or the current status of the domain name (e.g., “Web Site Status: ACTIVE”). This data may be used to identify any breaks in control of the domain name. In some embodiments, domain history software 300 may access online services with access to additional WHOIS records. These records may establish a history of ownership of the domain name, which may not only establish a chain of title for all past transactions, but may also track control of the domain name into the future.

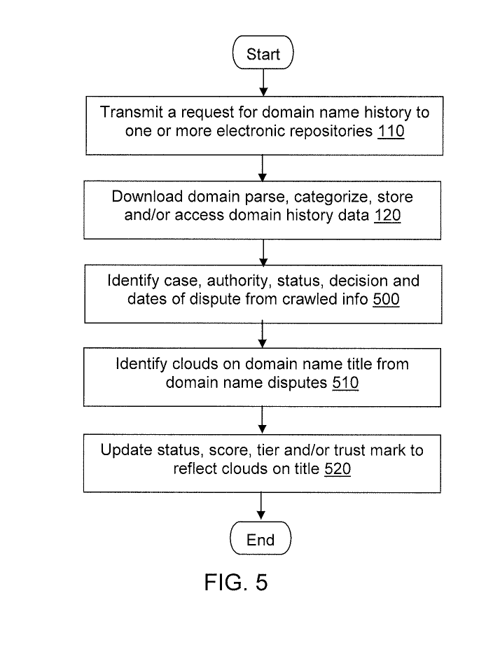

The domain history software 300 may also be configured to perform the method illustrated in FIG. 5 to identify any clouds on the domain name title, by transmitting, via network 200, a request to access the one or more electronic repositories 310 (Step 100). The request may identify one or more domain names for which the domain dispute data is requested, and may include instructions to identify and download relevant historical data about the identified domain name(s), such as disputes about the domain name's control. To accomplish this, the domain history software 300 may be configured to perform an Internet crawl and/or scrape data from posted data documenting a history of disputes, if any, related to control of the relevant domain name. Non-limiting examples of disputes that may arise regarding domain name control may include: disputes under the UDRP; disputes filed with the registry, ICANN or a dispute panel; UDRP jurisprudence filed and reported by the TLD registry, etc.

Domain dispute data sources may include any publicly-available web page and/or database. A compilation of URLs for these websites may be stored in data storage 230 and accessible to the domain history software 300. The domain history software 300 may include logic to access each of the URLs, and further instructions on how to access, crawl, scrape and/or otherwise acquire the content stored on these websites. Additional domain dispute data sources may include URLs available via the ICANN website identifying a list of approved dispute resolution providers. The domain history software may parse and access additional domain dispute data via the contact information provided by ICANN.

As non-limiting examples, the domain history software 300 may be configured to crawl websites such as the “List of Proceedings Under Uniform Domain Name Dispute Resolution Policy” web page available via the ICANN website or the “Index of WIPO UDRP Panel Decisions” and “Search WIPO Cases and WIPO Panel Decisions” web pages available via the WIPO website. Where available, API, RSS feeds and/or web services may also be used to access these or any other available resources from authorities authorized to hear domain disputes.

The domain history software 300 may be configured to receive the requested/crawled/scraped information and parse domain dispute-related data (Step 110) to identify, if available: 1) the domain name in dispute; 2) the type of case (e.g., UDRP, WIPO Panel, etc.); 3) the authority overseeing the domain name dispute (e.g., ICANN, UDRP Jurisprudence WIPO Panel, court overseeing the dispute, etc.); 4) the start date of the dispute; 5) the decision date of the dispute; and/or 6) the status and/or panel decision, as non-limiting examples (Step 500).

In the proactive embodiments described below, a standard notification system, or notification of a site lock on a particular domain name may also indicate a current domain name dispute.

The domain history software 300 may be configured to identify any unresolved domain disputes as clouds on the domain name title, and may update data storage 230 accordingly (Step 510). The domain history software 300 may work in conjunction with the domain trust score software 305, as described below, to update the status, score, tier and/or trust mark associated with the domain name to reflect any identified clouds on the domain name title (Step 520).

In some embodiments, the domain history software 300 may be configured to request, download, parse and process additional data from the electronic repository to reflect a more accurate domain name history.

Specifically, the domain history software 300 may use this additional data to identify additional clouds on the domain name title. As a non-limiting example the domain history software 300 may be configured to crawl the content of the website associated with the domain name to compare against keywords indicating that the domain name and/or website has been seized by a government agency, such as the FBI, because of illegal activity. The domain history software 300 may then be configured to identify the content identifying such a seizure as a cloud on the domain name.

Other non-limiting examples of additional clouds on the domain name may include data associated with the domain name registrar, name servers and or registrant. Specifically, the domain history software 300 may access the domain name's WHOIS records to identify the domain name's registrar. The domain history software 300 may then compare the registrar against a database, possibly within data storage 230, of trusted and suspect registrars. If the domain name is hosted with a suspect registrar, this may constitute a cloud on the domain name. By contrast, if the domain name has been hosted long-term with a trusted registrar, this could improve the domain name's status for trust mark purposes, described below.

Similarly, the domain history software 300 may identify, within the WHOIS or domain name system (DNS) records, the name servers associated with the domain name. These name servers may be cross referenced against the database of suspect registrars previously described to see if these name servers resolve to the name servers of suspect registrars. If the name servers are associated with a suspect registrar, this may constitute a cloud on the domain name.

The domain history software 300 may also identify registrant data within the WHOIS record and compare the identified registrant with a database identifying one or more suspects (and/or their known aliases) involved in domain hijacking. If the identified registrant matches a known domain hijacking suspect, this may constitute a cloud on the domain name.

In some embodiments, the domain history software 300 may be configured to proactively aggregate a collection of data about the domain name history by requesting, downloading and processing domain name transaction data available via the electronic repositories 310.

In these embodiments, the domain name history, as well as the verification of the domain name, described below, may be immediately available to users. Such embodiments may be useful for an aggregation and/or listing service that lists all available domain names where users desire access to domain name information without requiring a search. The users could access the pre-assembled list of domain names to review which domain names have been verified and view the domain name history for each listed domain name.

In such proactive system embodiments, one or more triggers may cause the domain history software 300 to begin the process of aggregating the history data for the domain name as previously described.

As a non-limiting example of such a trigger, the domain history software 300 may be configured to regularly (e.g., daily) crawl the previously described data sources documenting a history of disputes in order to identify domain names with potential clouds on their domain name title. If such a cloud is identified for a domain name, the domain history software 300 may be configured to crawl any additional data sources, as previously described (e.g., WHOIS records, Internet crawl for related news or information related to the domain name, etc.) to aggregate a body of stored information about the domain name.

Another non-limiting example of a trigger for aggregating history data for a domain name may include a listing in a domain name aftermarket for a high value domain name. High value domain names may be determined by an administrator of the domain name aftermarket or by the domain history software, but as a non-limiting example, may include domain names being listed for over $10,000.00 or another pre-determined monetary value.

The information aggregated in response to the triggers, including any breaks in chain of title or clouds on the domain name title, and/or trust mark data as described below, may then be transmitted to one or more domain name listing services, such as a domain name aftermarket as a non-limiting example, which may then make the information available to potential clients without requiring a specific search for information about the domain name.

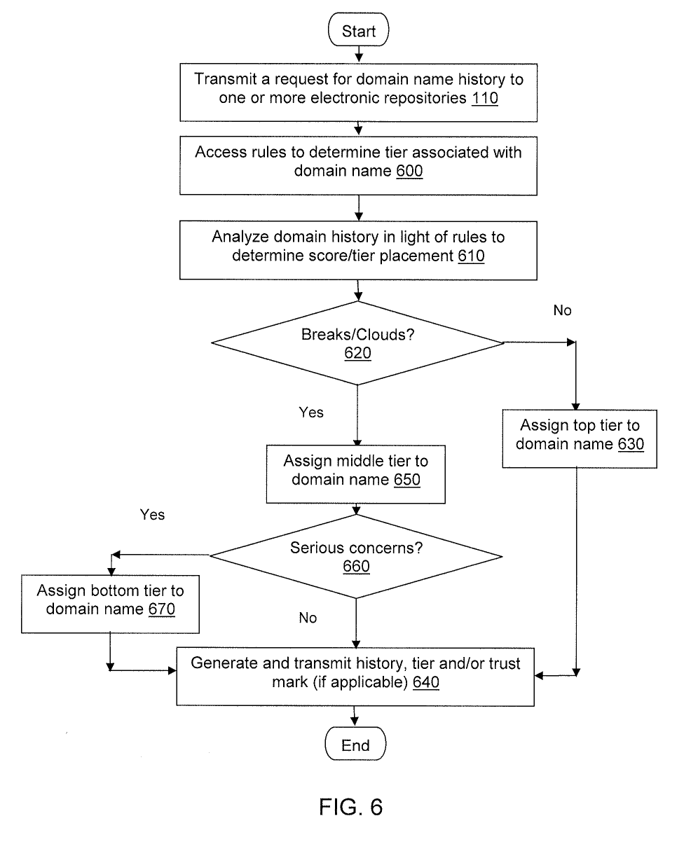

As seen in FIG. 6, one or more domain name report software modules 305 running on server(s) 210 may work in conjunction with one or more domain history modules 300, either or both of which may be configured to receive, from a user interface 315 running and displayed on client(s) 220, transmission of a request for: 1) a report comprising an analysis of the results of a history search for the domain name; and/or 2) a verified trust mark to be applied to the domain name and displayed in association with the domain name in a domain name listing.

As a non-limiting example, a buyer may be interested in purchasing a domain name. In light of the trust mark system described below, the potential buyer may request that the current domain name owner request a history search for the domain name so that their domain name is accompanied by an appropriate trust mark when displayed in various domain name listings. The domain name owner or potential domain name buyer may access a user interface 315 configured to receive a request from the user for a history search and/or a trust mark related to one or more domain names that the buyer is interested in purchasing.

The domain report software 305 may receive the request, and parse the request to identify the domain name to be searched (Steps 110-120). The domain report software 305 may then search the data sources described above and/or any records associated with the domain name in data storage 230. These records may be relevant to, as non-limiting examples, the domain name history, the domain's chain of title, any clouds or other anomalies within this history of domain name control, or any other notable transactions or information within the domain name history.

The domain report software 305 may be configured to access one or more rules used to calculate and/or define the level of clear title the owner has in the domain name (Step 600). The one or more rules may comprise logic, algorithms and/or other software instructions used to calculate a threshold wherein, if the domain name history indicates that certain minimum requirements have been met, then control of the domain name throughout its history may be deemed “verified” and/or associated with a trust mark. The instructions defining these rules may be stored in data storage and accessible to the domain report software 305, and/or may be found in the logic/algorithms of the domain report software 305 itself.

The rules may define a tiered trust mark system used to identify a tier and/or other verification score associated with the domain name. In some embodiments, the domain report software 305 may be configured to generate and display a trust mark, possibly comprising an industry recognized logo (possibly displaying language of verification), a score, color scheme, symbol or other means of indicating a verification of the history and/or title of the associated domain name. By way of analogy, the tiered trust mark system may be similar to colors or symbols used in a website browser to identify websites using authenticated security certificates from verified sources.

The one or more rules may comprise parameters that define the structure of the tiered trust mark system. In some embodiments, a software engineer or system administrator may design the system to include the parameters, logic and/or algorithms for each rule. In other embodiments, the parameters, logic and/or algorithms of each rule may be defined and or updated by individual users via a user interface 315 on client(s) 220. Input received from the user interface 315 may be transmitted to server(s) 210, stored in data storage 230, and later accessed and analyzed to determine the trust level associated with a particular domain name.

The rules and parameters may define the tiers that make up the structure of the tiered trust mark system. In such a system, the rules and parameters may define the number of tiers, one or more threshold numbers that define the boundaries/limitations of each of the one or more tiers, one or more threshold numbers for defining a high-value domain name in a domain name aftermarket, etc.

One non-limiting example may include a 3-tiered trust mark system. For demonstrative purposes, the three tiers may be divided into a top or “green” tier, a bottom or “red” tier and a middle or “yellow” tier. This example should place no limitations on the type of tiered system used. For example, additional types of tiered structures may include tiers based on a grading type tier (e.g., Pass/Fail, A-F, 100%, 75% etc.), or any other type of tiered scoring system.

In this non-limiting example, the top tier may indicate domain names wherein all history records indicate that all domain-related records (e.g., WHOIS information) represent a complete and verified domain name history. A complete and verified domain name history may comprise a domain name history identified by the domain history software 300 to be free of breaks the domain name's chain of title, and that contain no clouds on the domain name title.

The bottom tier may be reserved for domain names where the domain name history indicates serious concerns regarding the ownership history, previous transactions or current disputes. Serious concerns may comprise any break in the domain name's chain of title, or one or more clouds on the title as previously described. Logic in the domain history software 300 or stored in data storage 230 may define one or more thresholds, such as a length of time for a break in a domain's chain of title or a type and/or number of clouds on the title, which cause the domain name to be associated with the bottom tier.

The middle tier may include domain names with some gaps or discrepancies in the domain's history, but in which all available information is verified. As non-limiting examples, this middle tier may include domain names where domain name ownership is unclear, but no serious concerns have been detected regarding the domain name's chain of title or clouds on the domain name title, or where any clouds on a domain name may soon be removed as domain name disputes reach their designated time to live, and be therefore be removed from the domain name history.

In some embodiments, the rules may define the parameters for the top and bottom tiers as being fixed (i.e., either a domain name qualifies for these tiers or it does not), while the middle tier may comprise more of a sliding scale or continuum approach, wherein a domain name may be closer to the top tier or the bottom tier, depending on the amount and accuracy of the data available.

The domain report software 305 may be configured to receive a request for history and/or trust mark for a domain name. The report module 305 may be configured to access the rules that define the parameters of the tier structure, as well as the historical data associated with the domain name.

In response to the request for the history and/or trust mark for the domain name (Step 100), the domain report module 305 may be configured to analyze the domain name's historical data, such as domain name history, consistent chain of title vs. breaks in the chain of title, disputes related to the domain name etc., in light of the tier structure defined in the rules. The domain report software 305 may then determine the domain name's score/placement within the tiered trust mark system according to the domain name history (Step 610).

As a non-limiting example, each domain analyzed may begin with a perfect score. The domain report module 305 may access records within data storage 230, and parse each record's data to identify any verified information. The domain report module 305 may then compare the historical data with the logic in the rules, which may establish the domain name as meeting the qualifications for the top or green tier (Step 630).

If a top tier status is maintained throughout the analysis of the domain name history, the domain report module 305 may be configured to generate a trust mark that indicates, within domain name listings, that the domain name has been verified (Step 640).

The domain name listing trust mark may comprise any mark (text, font, color, graphic, symbol, etc.) displayed in the domain name listing in conjunction with the domain name. As a non-limiting example, a website comprising a list of domain names available in a domain name aftermarket may include certain domains listed in green or displayed in conjunction with such a trust mark.

The domain report software 305 may be configured to identify, within the data storage records, any anomalies or ambiguities in the domain name history records as breaks in the chain of title, if the domain name does not qualify for top tier status (Step 620). These anomalies may be compared with the rules, which may require any anomalies or ambiguities to move the domain name into the middle or yellow tier (Step 650). The rules may further define the middle tier as more of a continuum, wherein, as each anomaly or ambiguity is identified, the domain name may be lowered in score according to the rules to move the domain name's status further from the top tier and closer to the bottom tier.

The domain report software 305 may then be configured to identify, within the data storage records, any disputes regarding control/ownership of the domain name, or any serious concerns regarding the ownership history of the domain name (Step 660). The rules may require that identification of any disputes regarding control/ownership of the domain name move the domain name into the bottom or red tier (Step 670).

The domain report software 305 may then use the aggregated information from the data sources and data storage 230 to generate: 1) a report comprising the domain name history and an indication of whether the domain name has been verified as having no concerns for the seller or buyer; and 2) the trust mark described previously, if the domain name has met the appropriate requirements (Step 640).

The report may comprise any of the domain history information included in the request by the client machine. As non-limiting examples, the report may comprise an ownership/control history, any breaks in the domain name ownership/control, any additional transactions found in searching the appropriate records, any current domain dispute actions or court actions, etc.

In some embodiments, the operator or administrator of the tiered trust mark system may partner with a domain reseller organization to create a tiered money back guarantee system. As a non-limiting example, a software running on the servers of the domain reseller organization may send a request to server(s) 210. The domain report module 305 may generate a report as previously described and may transmit the report, including the assigned tier, to the domain reseller's servers. Software running on these servers may then use the score and/or assigned tier to determine a percentage of a money back guarantee available to an aftermarket domain name purchaser, depending on the level of risk reflected in the tier assigned to the desired domain name. The domain name aftermarket organization may then display the percentage along with their money back guarantee information.

The server(s) 210 generating the display for the aftermarket/domain name may interpret the transmitted information and correlate the score/ranking with data for money-back guarantees associated with the domain name.

As a non-limiting example, the receiving server(s) 210 may contain logic providing a money back guarantee. However, if the domain name associated with the money back guarantee has a middle tier status, the money back guarantee may be reduced so that the buyer only gets 50% back, or none at all. Alternatively, money back guarantees may be available only to domain names with top tier status.

The steps included in the embodiments illustrated and described in relation to FIGS. 1-4 are not limited to the embodiment shown and may be combined in several different orders and modified within multiple other embodiments. Although disclosed in specific combinations within these figures, the steps disclosed may be independent, arranged and combined in any order and/or dependent on any other steps or combinations of steps.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method, comprising the steps of:
identifying, by a server computer communicatively coupled to a network, a domain name;
downloading, by the server computer, from an electronic repository of domain name data, a historical data associated with the domain name;
parsing, by the server computer, from the historical data, at least one transaction associated with the domain name;
calculating, by the server computer, according to the at least one transaction, a level of confidence that a history of control of the domain name is complete and accurate;
transmitting, by the server computer, to a client computer communicatively coupled to the network, the historical data.

2. The method of claim 1, wherein the electronic repository of domain name data comprises at least one electronic data source documenting a history of transactions or control disputes associated with the domain name, and wherein the at least one electronic data source comprises:
a publicly accessible database comprising the at least one transaction;
a web service comprising access to the at least one transaction;
an electronic data feed comprising the at least one transaction; or an aggregation of domain name data, comprising the at least one transaction, from an Internet crawl of at least one web page.

3. The method of claim 1, wherein the historical data associated with the domain name comprises:
a WHOIS record comprising:
a range of dates during which the domain name was registered; or
at least one registrant of the domain name;
at least one action wherein control of the domain name is in dispute;
a sale or registration of the domain name in a domain name aftermarket; or
a domain name data matching at least one keyword from an Internet crawl.

4. The method of claim 3, wherein the at least one transaction associated with the domain name comprises:
a transfer of ownership of the domain name as recorded in the WHOIS record; or
a challenge of domain name control in a domain name dispute.

5. The method of claim 1, further comprising the steps of:
identifying, by the server computer, within the historical data:
at least one action wherein control of the domain name is in dispute; and
a domain name chain of title data identified from the domain name in dispute;
aggregating, by the server computer, the at least one action and the domain name chain of title data; and
transmitting, by the server computer, the at least one action and the domain name chain of title data to a domain name listing service.

6. The method of claim 1, wherein:
identifying the domain name further comprises the step of receiving, by the server computer, a request for:
a report comprising an analysis of the historical data for the domain name; or
a trust mark displayed in association with the domain name to verify the domain name in a domain name listing; and
transmitting the historical data further comprises the steps of:
generating, by the server computer, the report or the trust mark; and
transmitting, by the server computer, the report or the trust mark to the client computer.

7. The method of claim 1, wherein the level of confidence is expressed according to a plurality of tiers representing a level of completeness and accuracy of the history of control of the domain name, wherein:
a top tier indicates that all records are complete and verified;
a bottom tier indicates the existence of at least one serious concern regarding the history of control of the domain name; and
a middle tier indicates at least one discrepancy in the history of control of the domain name, wherein all available information is verified.

8. A method, comprising the steps of:
receiving, by a server computer communicatively coupled to a network, a web services request for a historical data associated with a domain name and accessible via an electronic repository of domain name data;
aggregating, by the server computer, from the electronic repository, the historical data, the historical data comprising:
at least one transaction to be parsed from the historical data, the at least one transaction being associated with the domain name; and
at least one ownership data used to calculate, according to the at least one transaction, a level of confidence that a history of control of the domain name is complete and accurate; and
transmitting, by the server computer, the historical data to a second server computer communicatively coupled to the network.

9. The method of claim 8, wherein the electronic repository of domain name data comprises at least one electronic data source documenting a history of transactions or control disputes associated with the domain name, wherein the at least one electronic data source comprises:
a publicly accessible database comprising the at least one transaction;
a web service comprising access to the at least one transaction;
an electronic data feed comprising the at least one transaction; or
an aggregation of domain name data, comprising the at least one transaction, from an Internet crawl of at least one web page.

10. The method of claim 8, wherein the historical data associated with the domain name comprises:
a WHOIS record comprising:
a range of dates during which the domain name was registered; or
at least one registrant of the domain name;
at least one action wherein control of the domain name is in dispute;
a sale or registration of the domain name in a domain name aftermarket; or
a domain name data matching at least one keyword from an Internet crawl.

11. The method of claim 10, wherein the at least one transaction associated with the domain name comprises:
a transfer of ownership of the domain name as recorded in the WHOIS record; or
a challenge of domain name control in a domain name dispute.

12. The method of claim 8, wherein the level of confidence is expressed according to a plurality of tiers representing a level of completeness and accuracy of the history of control of the domain name, wherein:
a top tier indicates that all records are complete and verified;
a bottom tier indicates the existence of at least one serious concern regarding the history of control of the domain name; and
a middle tier indicates at least one discrepancy in the history of control of the domain name, wherein all available information is verified.

13. A system, comprising:
an electronic repository of domain name data communicatively coupled to a network and configured to receive a request for a historical data associated with a domain name; and
a computer communicatively coupled to the network and configured to:
download the historical data from the electronic repository;
parse, from the historical data, at least one transaction associated with the domain name; and
calculate, according to the at least one transaction, a level of confidence that a history of control of the domain name is complete and accurate.

14. The system of claim 13, wherein the electronic repository of domain name data comprises at least one electronic data source documenting a history of transactions or control disputes associated with the domain name, wherein the at least one electronic data source comprises:
a publicly accessible database comprising the at least one transaction;
a web service comprising access to the at least one transaction;
an electronic data feed comprising the at least one transaction; or
an aggregation of domain name data, comprising the at least one transaction, from an Internet crawl of at least one web page.

15. The system of claim 13, wherein the historical data associated with the domain name comprises:
a WHOIS record comprising:
a range of dates during which the domain name was registered; or
at least one registrant of the domain name;
at least one action wherein control of the domain name is in dispute;
a sale or registration of the domain name in a domain name aftermarket; or
a domain name data matching at least one keyword from an Internet crawl.

16. The system of claim 15, wherein the at least one transaction associated with the domain name comprises:
a transfer of ownership of the domain name as recorded in the WHOIS record; or
a challenge of domain name control in a domain name dispute.

17. The system of claim 13, wherein the level of confidence is expressed according to a plurality of tiers representing a level of completeness and accuracy of the history of control of the domain name, wherein:
a top tier indicates that all records are complete and verified;
a bottom tier indicates the existence of at least one serious concern regarding the history of control of the domain name; and
a middle tier indicates at least one discrepancy in the history of control of the domain name, wherein all available information is verified.
